(19) United States
(12) Patent Application Publication
(10) Pub. No.: US 2025/0211629 A1
(43) Pub. Date: Jun. 26, 2025

(54) SYSTEM AND METHOD FOR MANAGING AND GENERATING EXCHANGES OF KNOWLEDGE, DATA, INFORMATION AND/OR DATABASES AMONG USERS VIRTUALLY AND/OR DIGITALLY

(71) Applicants: Agustin VELÁZQUEZ GARCÍA-LÓPEZ, Yucatán (MX); Pedro Alfonso RODRÍGUEZ REYNAGA, Yucatán (MX); Joaquín ALCOCER ÁVILA, Mérida, Yucatán (MX); Analaura ESCALANTE GARCIADIEGO, Ciudad De México (MX)

(72) Inventors: Agustin VELÁZQUEZ GARCÍA-LÓPEZ, Mérida, Yucatán (MX); Pedro Alfonso RODRIGUEZ REYNAGA, Mérida, Yucatán (MX); Joaquín ALCOCER ÁVILA, Mérida, Yucatán (MX); Analaura ESCALANTE GARCIADIEGO, Cuajimalpa De Morelos, Ciudad De México (MX)

(21) Appl. No.: 18/705,570

(22) PCT Filed: Oct. 27, 2022
(86) PCT No.: PCT/IB2022/060346

§ 371 Date: Apr. 28, 2024

(30) Foreign Application Priority Data
Oct. 29, 2021 (MX) MX/A/2021/013410

(51) Int. Cl. H04L 67/02; G06Q 10/06

(52) U.S. Cl. CPC H04L 67/02; G06Q 10/06

(57) ABSTRACT

The present invention is related to a system and method to manage and generate exchanges of knowledge, data, information and/or databases between users virtually and/or digitally, which comprises: a plurality of devices for receiving and sending Instructions and Information Requests; an administrative control device; a general module server; a billing and payroll system server; an artificial intelligence system server; a web page creation system server; and, a conference and workshop system server.

The present invention allows the creation, production, facilitation, and acquisition in a single place and virtually from the site where a user is, documents, digital products and/or services that are available anywhere, as if it were on the physical site where said documents, digital products and/or services are offered.

### FIELD OF THE INVENTION

The present invention refers to systems that allow users to manage and generate exchanges of knowledge, data, information and/or databases remotely using electronic means, to be able to access documents, digital products and/or services, and more particularly it relates to a system and method to manage and generate exchanges of knowledge, data, information and/or databases between users virtually and/or digitally.

### BACKGROUND OF THE INVENTION

In a society as complex as the one we live in today, it is common that during the course of our daily activities, the need arises to find a way to have access to the exchange of knowledge, data, information and/or base of data remotely without having a fixed physical space in which to carry out the exchange, at the same time using virtual currency accepted by the community in the same digital and/or virtual world.

In a globalized world, the possibility of holding meetings virtually and/or digitally has allowed distances to be shortened and videoconferences can be held from anywhere in the world; however, to date there is no holistic solution that allows finding in a single place, virtually and/or digitally, a system and/or tool that allows having a virtual and/or digital space to obtain access to documents, digital products and/or services, that is, all types of knowledge, data, information and/or databases offered in the physical world (anywhere in the world), that can make available to a user a solution to their common needs of the physical world and traditional businesses, through a virtual and/or digital system to manage and generate exchanges of knowledge, data, information and/or databases between users with the option of making payments with virtual currency accepted by users or community and/or traditional payment method in the same digital and/or virtual place.

Thus, until now there is no system that allows acquiring in a single place and virtually and/or digitally, knowledge, data, information and/or databases that are available throughout the world, just like being in the physical place where they are offered.

Now, regarding the state of the art, document CN111985908 describes a shared cloud office platform, comprising a cloud server, an intelligent office system and a cloud terminal, where the cloud terminal is connected with the smart office system through the cloud server, the smart office system comprises a message module, a work module, a market module, an office module and a personal module, and the message module comprises a demand posting unit, a project creation unit and a team creation unit; and the market module comprises a demand library and an expert library, the demand library comprises demands from several different industries, each demand corresponds to a certain reward, the expert library is connected with big data through a cloud server and is used to collect experts from several different industries, and the demand posting unit is connected to the demand library. By means of the cloud office platform, a project or organization team can be quickly created, experts in the corresponding fields are collected in an online mode to complete the work in an online communication and cooperation mode, a remote online office is carried out on the premise that there are no limitations of time, regions and organization, and the cloud office platform is efficient and fast.

On the other hand, in patent document CN109150883, a remote management system based on the intelligent positioning of equipment is provided. The system comprises client software installed on a smart device of an employer and remote management server software installed on a remote server; the client software includes an employee practical address collection module, a customer communication module and a virtual office location module; and the remote management server software comprises an employee information recording module, a server communication module and an employee virtual position calculation module. Through the cooperation between modules, the positioning of smart devices in the same physical office location originally can be extended infinitely, employees in different office locations are gathered in a virtual office space, and the experience of office where employees and leaders are in the same room is achieved.

Likewise, document KR10-2015-0069699 describes a system for providing a service based on a cloud virtual office address. According to the invention, a device for providing a service based on a cloud virtual office address includes a server storage part that stores information by cloud virtual office user; and a server control part that provides a cloud virtual office address in accordance with a request for opening a cloud virtual office, and provides an input security function, a tax invoice issuance function, a tax reporting function, a surcharge and an income tax reporting function, a tax payment function, a notification, reading and designated data transmission function, a function of providing basic data capacity per office in the cloud, and a visitor message function, based on the address of the given cloud virtual office.

As can be seen in the above mentioned documents, the state of the art does not provide the characteristic or option of being able to purchase in a single place and virtually and/or digitally from the site where a user is located, documents, digital products and/or services that are available anywhere in the world, just like being in the physical place where they are offered.

The documents that make up the prior art do not solve the problem of being able to access a virtual and/or digital office personalized for each user, which integrates multiple modules from multiple servers to have and give access, through a user server, to different tools for the creation of knowledge, data, information and/or databases, and the development of daily work activities such as, among others, invoicing, collection, control of matters or client files, holding conferences, purchase of office equipment and supplies, request for professional services, scheduling of them, blocking appointments for meetings, simultaneous communication with various users, request for transportation services, creation of web pages, virtual and/or digital office addresses, lines of communication known or yet to be known, exchange of information, payment of contracted services with virtual currencies or traditional currencies, automatic qualification of contracted services and positive or negative comments regarding them, etc.

By virtue of the above, we have sought to eliminate the drawbacks of the previous technique, developing a system and method to manage and generate exchanges of knowledge, data, information and/or databases between users virtually and/or digitally, which makes it possible to provide a user with solutions to their analogous needs from the physical world and traditional businesses through virtual interaction.

The system and method to manage and generate exchanges of knowledge, data, information and/or databases between users virtually and/or digitally of the present invention, can perform various functions through external servers known or yet to be known to support processes or problems already solved by them, however, their results are used in different ways and for different purposes within the system, it also decides through which server device it will make the connection to these external servers in the most efficient way possible by selecting servers dedicated to specific functions, as an example is a server that connects to the external server of the local Tax Office, as it contains the most advanced security and encryption measures of the entire system, so that the processing capabilities of this server are used to exchange tax information through it.

In this way, the system to manage and generate exchanges of knowledge, data, information and/or databases between users virtually and/or digitally in the present invention, solves the problem of being able to use various servers to carry out specific tasks within the same system, where each of the servers is responsible for particular tasks and which, together, form an ecosystem (virtual or digital office) that has the technical advantages of freeing processes from certain servers, optimizing processes using server specifications that improve the processing performance of each one, preserve files and information more securely and store large amounts of information without harming other processes, as well as the operation of the servers while being able to obtain all types of knowledge, data, information and/or database, as well as documents, digital products and/or services of all kinds with payments in virtual currency accepted by the community itself or in traditional payment formats.

Likewise, the creation and exchange of intangibles, which in turn are recognized, shared and/or exchanged by users who recognize a value, that is, generating an economic balance between the creator, the time invested in generating the intangible and recognition, usefulness and/or pertinency that the receiving users give it and for which they grant a virtual value that is tradeable or exchangeable on the platform itself.

### OBJECTS OF THE INVENTION

It is an object of the present invention to provide a system and method to manage and generate exchanges of information (understanding this as knowledge, data, information and/or database, hereinafter exclusively information) between users virtually (understanding this as virtual and/or digital, hereinafter exclusively virtual), which allows a user to have a virtual space in the place where they are, to be able to access services or documents (understanding this as documents, digital products and/or services, hereinafter documents) available anywhere in the world.

It is another object of the present invention to provide a system and method to manage and generate information exchanges between users virtually, which makes it possible to make available to a user through virtual interaction, solutions to their common needs in the physical world and the traditional business, through access to all types of information.

An additional object of the present invention is to provide a system and method to manage and generate information exchanges between users virtually, which allows access to professionals and/or providers of any specialty and anywhere in the world virtually, from their place of origin.

It is another additional object of the present invention, to provide a system and method to manage and generate exchanges of information between users virtually, which allows a user to have a virtual interaction from their place of origin, with professionals and/or suppliers anywhere in the world, who may respond to the requirement with a proposal based on their experience, availability, prestige, cost of the service in traditional currency or virtual currency, so that the user can choose provider that best suits its needs.

An additional object of the present invention is to provide a system and method to manage and generate information exchanges between users virtually, which allows the creation and exchange of intangibles (digital products and/or services), recognized and shared by users, to which a previously agreed value is assigned in any type of currency.

### BRIEF DESCRIPTION OF THE INVENTION

The present invention relates to a system and method to manage and generate exchanges of knowledge, data, information and/or databases between users virtually and/Or digitally 100, constructed in accordance with a particularly preferred embodiment of the present invention, which should be considered only as illustrative, but not limiting thereof, where said system is made up of at least seven main elements, namely: a plurality of devices for receiving and sending Instructions and Information Requests (ISI) 10; an administrative control device 20 (administrative dashboard); a general module server 30; a invoicing and payroll system server 40; an artificial intelligence system server 50; a web page creation system server 60; and, a conference and workshop system server 70.

The present invention makes it possible to acquire in a single place and virtually from the site where a user is located, documents, digital products and/or services that are available anywhere in the solar system or the universe, just like being in the physical place where said documents, digital products and/or services are offered.

### BRIEF DESCRIPTION OF THE FIGURES

The novel aspects that are considered characteristic of the present invention will be established in particular in the accompanying claims. However, the invention itself, both for its structure and functionality, together with other objects and advantages thereof, will be better understood from the following detailed description of a preferred embodiment, when read in conjunction with the accompanying figures, in which:

FIG. 1 shows a block diagram of the arrangement of the elements that make up a preferred modality of a system to manage and generate exchanges of knowledge, data, information and/or databases between users virtually and/or digitally.

FIG. 2 shows a block diagram of the interaction of the elements that make up the system of the present invention, to show a method to manage and generate exchanges of knowledge, data, information and/or databases between users virtually and/or digitally, in accordance with a preferred modality.

### DETAILED DESCRIPTION OF THE INVENTION

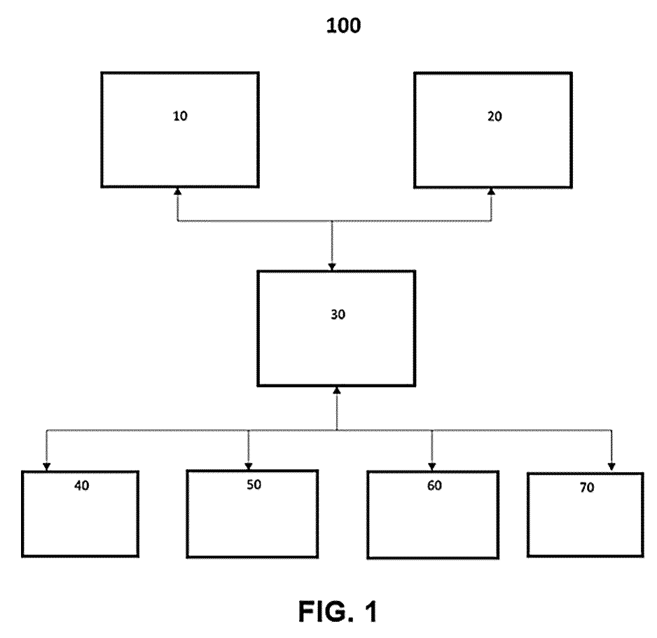

Referring to the accompanying drawing, and more specifically to FIG. 1, it shows a system 100 to manage and generate information exchanges (understanding this as knowledge, data, information and/or databases, hereinafter exclusively information) between users virtually (understanding this as virtual and/or digital, hereinafter exclusively virtual), constructed in accordance with a particularly preferred embodiment of the present invention, which should be considered solely as illustrative, but not limiting thereof, where said system is made up of at least seven main elements, namely: a plurality of devices for receiving and sending Instructions and Information Requests (ISI) 10; an administrative control device 20 (administrative dashboard); a general module server 30; a invoicing and payroll system server 40; an artificial intelligence system server 50; a web page creation system server 60; and, a conference and workshop system server 70.

Referring to FIG. 1, it shows the interrelation of the different elements that make up the system to manage and generate information exchanges between users virtually 100, said system in a preferred embodiment comprises:
a plurality of devices for receiving and sending Instructions and Information Requests (ISI) 10, where the ISI's made by an initial user are generated and sent to a general module server 30 for processing;
an administrative control device 20 (administrative dashboard), which generates control, configuration and authorization ISIs, and communicates them directly to the server 30, so that they are reflected in the operation or response of this and the others devices according to the action performed (e.g. authorization to accept a new allied user of device 10, configuration to show new documents on server 30, authorization to create invoices on server 40, etc.), device 20 in turn receives ISI's of database, dates, logbooks, to supervise, authorize, decline, eliminate information, users, modules, sections and other information contained and/or controlled by the server 30;
a general module server 30, which is also interconnected with an administrative control device 20 (administrative dashboard), with a invoicing and payroll system server 40, with an artificial intelligence system server 50, with a web page creation system server 60 and a conference and workshop system server 70, which intervene in all parts of the ISI's process, the general module server 30 is responsible for receiving and sending information from and in direction of the plurality of ISI's receiving and sending devices 10, to the administrative control device 20 (administrative dashboard), to the invoicing and payroll system server 40, to the artificial intelligence system server 50, to the web page creation system server 60 and to the conference and workshop system server 70, to process it and allow all the functionalities of the system 100 to be carried out, which include, among others: requesting professional services, scheduling a virtual/in-person appointment, schedule and receive payments, view and share news, view links and redirect them, download and share documents, receive and answer questions, register users, exchange electronic messages (chatting), follow-up of virtual/in-person appointments and contracted services, geolocation, unification of services, attention and support to users, simultaneous communication with various users, control of matters, control of records, invoicing, collection, encryption and storage of files and tax data, stamping of payrolls, virtual assistant, web page creation, virtual and/or digital office addresses, known or yet to be known lines of communication, exchange of information, broadcasting of webinars, holding conferences, sending messages, sending newsletters, purchasing office equipment and supplies, transportation services request, payment for contracted services with virtual currencies or traditional currencies, automatic qualification of contracted services, among others, to produce a response in the form of ISI to be sent to a device 20, or else, back to the same device 10, when the ISI received by the server 30 does not correspond to information that will be fully processed in the general modules, it is partially processed in order to be sent to another of the corresponding server devices and complement its processing;
a invoicing and payroll system server 40 that is interconnected to the server 30 and the other components of the system 100 through said server 30, which receives the ISI's corresponding to invoicing and/or payroll, to process them and generate a response that is sent back to the server 30, which forwards said response to one of the devices 10, 20 or both, the server 40 controls the issuance and stamping of invoices and payrolls in the local Tax Offices to users who use the service, in addition to saving the key user information local Tax Office to carry out the stamping;
an artificial intelligence system server 50 that is interconnected to the server 30 and the other components of the system 100 through said server 30, the server 50 when it receives one or some ISI's from the device 10, is responsible for processing them to generate a response that will be sent back to server 30 where it will be processed and forwarded as appropriate to one of the devices 10, 20 or both, in server 50 is stored all the information required to execute processes, such as, among other, keywords, their frequency, statistics and other relevant knowledge and information that is required, in addition to save all that knowledge and/or information in a module dedicated to “machine learning”;
a web page creation system server 60 that is interconnected to the server 30 and the other components of the system 100 through said server 30, said server 60 is linked directly through the server 30 to a user of the plurality of devices 10, so that when any of these devices 10 performs any ISI that corresponds to the web page creation system, the server 30 will operate as an intermediary to indicate which of the personalized configurations of the device 60 corresponds to the user of the device 10, which sends and receives the ISI, the server 30 being designed to store the information of the web pages that users create using the predesigned layouts (templates), where each web page will function as a subdomain attached to the system main domain; and,
a conference and workshop system server 70 that is interconnected to the server 30 and the other components of the system 100 through said server 30, which receives the ISI's from the devices 10 and 20 that were processed through server 30 and corresponding to conferences and workshops, for their execution, where will be made and stored live video transmissions (streaming).

The plurality of devices for receiving/sending Instructions 10 are responsible for generating the ISIs made by an initial user of this system to manage and exchange information between a company and its clients 100, which are sent to the general module server for processing. Said ISI depends on the digital product type and/or service that the initial user requires at that moment, in addition to including said ISI, personal information of the end user who will obtain the desired digital product and/or service, such as, among others, their cell phone number or email address. It is worth mentioning that among the digital products and/or services that can be acquired through system 100 of the present invention, using the plurality of devices 10, there are, among others:
a) ask questions using a question module located on device 10, in addition to being able to view the answers to the questions previously asked by other devices 10 and being able to share them in known and yet to be known digital and/or virtual communication systems, by sending these systems a unique URL and metadata (URL—Uniform Resource Locator, which is the unique and specific address that is assigned to each of the resources available on the web), the questions are captured in the question module and are sent to the server 30 that stores them and the latter sends a notification to device 20 indicating the creation of a new question, so that a user of the device 20 can view the question and capture an answer that is sent and stored in the server 30 for viewing by the user of the device 10 who asked said question; the user of one of the devices 20 can authorize the question and answer to be viewed by all users of the devices 10, and can also create from the interface of the devices 20 a question, its answer, and authorize it to be saved on server 30 and can be viewed by users of the devices 10 with permission to access them;
b) register users (Individuals and Legal Persons) in the general or company modality, whose information is stored in server 30, which notifies the devices 20 for their review and authorization of the user type, the device 20 after verifying the data, may authorize the entry of device 10 in general or company modality, where the company user modality has more functionalities that are not available for general users (these are clients of the Company Users), which will be described later, the devices 10 can view the user data stored according to their geolocation to be able to schedule appointments;
c) schedule appointments according to availability in the users agenda, so once the date and time is selected, the appointment is stored in the server 30 and a logbook is generated, which is notified to the device 10 and device 20 so that they can view the logbook; devices 10 with scheduled appointments, whether general user or company user, have access to a chat module, where they can contact to send text messages, multimedia messages and attached files, working the server 30 as an intermediary for this functionality and storing all the chat information, which can be viewed from the device 20 as long as it is authorized for informative references; from the first file that is sent, a folder will be created in the record module with the service name to which the chat corresponds and the corresponding appointment, the files that are saved in the record are stored on server 30, these files can be consulted by the devices 10 assigned to that service and any device 20 With authorization; once the service has ended, the files can only be accessed by the device 10 of the user who contracted the service or until the user grants access to other devices 10 during the duration of another service; additionally, even after the service has ended, the authorized devices 20 will always have access to this information;
d) follow up on the contracted service through appointments, for which the users of the devices 10, whether general or business, follow up on the contracted service through an appointment using a calendar with the days and times corresponding to each scheduled meeting, whether in person or virtual, with the assistance of Artificial Intelligence, and/or with technology known and yet to be known; the agenda data is stored on server 30 to be consulted by the devices 10 that correspond to it, or else, through any device 20 with authorization to consult the information logbook; the agenda indicates the appointment data, which are among others: host (the general user chooses between being himself or assigning one of the company users), participants, meeting link if it is virtual (for the online session, third-party services such as Zoom or similar are used) or location if the appointment is in person (for the location, the service offered by Google Maps or similar technologies are used); the virtual meeting link is generated when a device 10 selects said option, the information is sent to server 30 that stores the participant information and schedules the meeting, at that moment a connection is made with a device external to the system by making a request of URL generation to use one of the external services used; the external service returns a response with the URL assigned to said meeting, marking the previously selected user as host, this link redirects to the external service for the virtual meeting application, and is stored on server 30 that made the query, for future access to the information for the corresponding devices 10; in the event that the meeting is in person, the device 10 that is scheduling the appointment sends the information to the server 30, which stores the modality and the corresponding data, when the device 10 tries to select the location of the meeting, the server 30 consults the geolocation of the device 10 in question and, using an external service, sends it the coordinates to be able to position on the map of the external service, the current location of the user of device 10 which is scheduling the appointment; the user can decide to select between that location, a previously stored one or create a new one for the meeting place, when selecting the location on the map, the coordinates are sent again to the server 30 so that it can send it to the external service and receive in response the appropriate information to display on the map and generate the location that must be sent back to the devices 10 that consult the meeting information;
e) unify services between several users of the devices 10, for which a general user, when contracting services with company users, can convert several open services into one, when this is done, all the company users which have selected the general user will be able to contact them and schedule an appointment at the same time, creating a shared meeting or appointment between the user and two or more contracted company users (this is when the performance of a service requires several suppliers), the general user will be able to join the company users in the appointment, and select from himself or a company user which will be the host of the meeting, the user assigned as host can select the meeting type, whether in-person or online, all users of device 10 scheduled in the meeting can accept, or request to reschedule the meeting, if rescheduling is requested, the information is sent and stored on server 30, which in turn sends a notification to all other users of devices 10 assigned to the meeting, with the new time proposal for acceptance, once everyone accepts the date and time, the meeting will be confirmed and stored on server 30 so that when the devices 10 or a device 20 with authorization consult the information of the scheduled meeting, can viewing in the logbook;
f) provide attention and support to the users of the general and business devices 10, through a user attention and support module, which can create a matter in which help is requested and is described the problem, information which is sent and saved on server 30, which sends a notification to the authorized device 20 so that it can respond to said request, once the problem is solved, the response of the request is sent to server 30 for storage and sending of the notification to the corresponding device 10, which can consult the response and add a new request for attention if required.

Each of the ISI's receiving/sending devices of device 10, which make up the plurality of instruction receiving/sending devices 10, comprises all those electronic components necessary for the reception, processing, generation and sending of the ISI's selected by an initial user of the present system 100, as well as all those electronic components necessary for its interconnection with the general module server 30.

Among the main components that make up each of said devices 10 are at least one power source and/or battery; a processor; a ROM type memory unit; a RAM type memory unit; a network card; an input peripheral; and an output peripheral. Examples of said devices for receiving/sending instructions may be computers, cell phones, tablets, automated teller machines, point-of-sale terminals, among others.

The administrative control device 20 (administrative dashboard) is where the ISI's that control the system configurations 100 in their entirety are received and generated, said ISI's are transferred between the administrative control device 20 and the general module server 30; in addition to allowing the creation and cancellation of administrator users so that they can access the device 20 and grant them module permissions of this device to which they can access and read, edit and/or delete information.

Users of device 20 with appropriate permissions can access the user list of devices 10 registered in system 100 and consult their registration information. They can also consult and edit the user information of the devices 10 registered as companies, register and cancel said users, sending the ISI's to the server 30 to be processed and view the changes in the devices 10 that consult them. In the information of the company users, a geolocation location is consulted, edited, or created, which is sent from the device 20 to the server 30, which upon receiving said information processes it and sends it to an external service (map application server on the web), to receive the location on a map and process it for future queries from the plurality of devices 10 and devices 20. Also, the users of the device 20 can consult the status of the company users in relation to the license to use the system 100, number of contracted modules (service offering, customer relationship management, invoicing, website, webinars), among others.

The administrative control device 20 allows access to the following modules that are hosted on the general services server 30: an artificial intelligence module; a links module; a sales module; a news module; a document module; an electronic invoicing module; a web page module; a module of webinars, workshops, and courses; a payment module; and a reporting module.

The artificial intelligence module through the device 20 performs the following functions: generating the database for the artificial intelligence system server 50; capture keyword information, possible automatic responses according to the keywords; and allow the consultation of the certainty percentage in the answer delivered to the users of the devices 10 that make use of this module so that through machine learning the answers are adapted and the certainty percentage increases. Device 20, when generating the information, sends it to server 30, which processes it to simplify it and send it appropriately to server 50, which stores, processes and generates its own results and statistics; all this information once processed is sends it back to the server 30, which converts it to a suitable reading mode to be consulted from the device 20. In the artificial intelligence module, devices 20 users who have authorization will be able to consult the information entered by others devices 20 of possible keywords with their corresponding responses and categories to which they correspond; the devices 20 user with the appropriate permissions can also consult all the information, from whom and when this information was entered, edit it and authorize it so that the server 30 marks the information as visible to the plurality of devices 10.

The link module allows the data of the URL links to be loaded and sent to the server 30 and stored for future consultation by the users of the plurality of devices 10.

The sales module allows a user of devices 20 to view the list of all appointment requests that have been made between the general users and the company users of the devices 10, this information is consulted on server 30 and the details of all the information can be read, such as, among others: date, involved company (companies), amount of the transaction(s) carried out, meeting type (virtual or in-person), if in person, geolocation information, chat, files of the generated record, status of scheduled appointments, current status and comments/ratings of completed services.

The news module allows creating and canceling news, once the information is generated, it is sent to a server 30, which stores it so that it can later be consulted by the devices 10. News can be scheduled to automatically publish on a specific date.

The document module allows generating the information of a document and loading a file of known or yet to be known text format, this information is sent and stored on server 30 to be consulted later from the device 10.

The electronic invoicing module allows to consult the information of company users who request access to the invoicing module of the devices 10, which is stored on server 30, the users of devices 20 with access to this module will be able to verify the information as truthful (this process is carried out due to the sensitivity of the information of the keys of the local Tax Office for the stamping. Once the information is verified as authentic, the users of the devices 10 will be able to access the invoicing functionalities. Users of devices 20 will be able to consult all the invoices made by accessing the information stored on server 30.

The web page module allows to consult information that is stored in the server 30, said information being the configuration that a company user of devices 10 who has requested the license to use this module has made for its Web page.

Devices 20 users with access will be able to access said configuration, consult it, modify it, or delete it due to inappropriate content or some other reason. If a device 20 would like to access the display of the web page, querying through server 30, the page information stored on server 60 is accessed and consulted to display the web page.

The webinar/workshop/course module allows access the device 20 to consult the information through the server 30, which processes it to store it and consult it in turn on server 70. In this module the devices 20 with access permission can consult the webinars/workshops/courses, created by the users of devices 10, this information includes upload date, availability date and cost. Devices 20 will be able to authorize the availability date once it is confirmed that the content for this module meets the terms and module use conditions on the side of devices 10.

The devices 20 with access to the user module with appropriate permissions, will be able to consult the information of a payment module on server 30 of all the licenses to use the payment modules that the company users have contracted, will be able to view the payment method, start and expiration date of the license, as well as when there is a higher-ranking permission, make refunds for payments made to system 100.

Regarding the payment method, any payment method known or to be known through the Internet may be used, using virtual currencies or traditional currencies, or else, through the generation and exchange of intangibles (digital products and/or services), recognized and shared by users, to which a previously agreed value is assigned.

The devices 20 with access to the payment module will be able to view all payments made to the system 100 by general users, this information is stored within server 30 and is consulted through it, the registered payments are for contracting a service to a company user or by requesting access to a webinar/workshop/course, devices 20 users with a higher-ranking permission will be able to refund payments made to the system 100 as required.

The reporting module allows generating various reports by consulting and processing the information stored in the server 30, these reports will be service sales statistics, contracted licenses, behavior statistics of the artificial intelligence server, statistics of web pages traffic, sales statistics of courses/workshops/webinars, among other statistics or any other report of key performance indicators.

The general module server 30, as previously mentioned, serves as a communication intermediary between the user devices 10, the administrative control device 20 (administrative dashboard), the invoicing and payroll system server 40, the artificial intelligence system server 50, the web page creation system server 60 and the conference and workshop system server 70, which intervene in all parts of the ISI's process.

The general module server 30 is responsible for receiving and sending information from and in direction of the plurality of ISI's reception and sending devices 10, to the administrative control device 20 (administrative dashboard), to the invoicing and payroll system server 40, to the artificial intelligence system server 50, to the web page creation system server 60 and to the conference and workshop system server 70, to process it and allow all the functionalities of the system 100 to be performed.

The general module server 30 stores all the data of general users, company users and administrator users, as well as the permissions of each of them, that is, which modules they can access, what information they can view, as well like all other access permissions that the system 100 might have.

All the notifications that are generated in the system 100 are controlled by the general module server 30, which in addition to storing the logbook of the notifications, assigns and distributes each of these according to the device, the user type, corresponding module, or notification type.

The general module server 30 stores the questions and answers generated between the device 10 for receiving and sending instruction and the artificial intelligence system server 50, and sends the questions asked to the server 50 to be processed and to be able to receive an answer, and also serves as interconnection with an external server to share outside the system the questions that users wish to share, these servers can belong to several external systems and communicate through their web services to link, by sending ISI's to these systems, of a unique URL and metadata; when the user of one of the administrative control devices 20 (administrative dashboard) authorizes the question and answer to be viewed by all users of the devices 10, this information is stored in the general module server 30.

When device 10 registers users in company mode, the information is stored on server 30; when device 20 authorizes the entry of device 10 in company mode, its status is stored in server 30.

When scheduling appointments, the information forms a logbook with users, schedules, locations, video call links, all the information is stored on server 30 and the chat module of the devices 10 generates a history of conversations and shared files, all these ISI's are also stored on server 30.

The user records generated during the services performed in the system are stored in highly encrypted form on server 30.

A virtual meeting link is generated when a device 10 selects said option, the information is sent to server 30 to be stored; the server makes a connection with a device external to the system 100 by making a URL request to use one of the external services used; the external service generates a URL for said meeting, and it is stored on server 30.

The server 30 consults the geolocation of the device 10 when it is required to generate locations within the system 100, which may be the address of the company user offices, the meeting address, among others. Using an external service, send to it the coordinates used in online mapping systems, and receives in response the appropriate information to display on the map and generate the location that it must send back to the devices 10 that consult the information.

The administrative devices 20 users can edit certain information of general users or companies of some modules and can also authorize or delete information; all these movements are stored on server 30, this information includes data on which administrator user made the movements and when.

The information coming from the artificial intelligence server 50 (results and statistics) is received by the server 30 and converted into information in a suitable reading mode to be consulted by the devices 20.

The server 30 stores the news uploaded by the administrative devices 20 users, so that they can later be consulted by the devices 10, in addition to also controlling the publication date.

The server 30 stores the files coming from the document module of the device 20, so that they can be consulted later from a device 10.

The server 30 stores the configuration information of a company user of devices 10, which has requested a license of web page module for his personalized page. The information on images, videos, and other types of graphic assets (assets) is stored directly on server 60, so the server 30 functions as an intermediary to accommodate said information and files according to the configuration.

The public access request of a web page created in the system 100 through the web page module of the company user devices 10, reaches the server 30, which confirms that the URL extension exists and requests the information to deploy it to server 60. Custom domains of company users can be used when they have one and it is configured, when the public access request information arrives at server 30 (to confirm the existence of this URL); a verification is made to external server, which must respond positively or negatively. In the positive case, the process continues by requesting the information from server 60; in the negative case, access is canceled, and an access error default page is displayed.

Server 30 stores all use license payment information made in system 100, as well as payments for services, workshops, webinars, conferences and other functions or accesses that require payments, this information includes dates, amounts, corresponding services, validity of licenses, frequency, among other data.

The reports generated by the devices 20 users are processed and stored in the server 30, these reports will be statistics of various data of the system 100, they may be sales of services, contracted licenses, behavior statistics of the artificial intelligence server, web page traffic statistics, sales statistics of courses/workshops/webinars, among others, or any other report of key performance indicators.

When a company user device 10 loads its electronic keys into the invoicing module, these files are sent to server 30, which verifies that the file format is correct, encrypts them and subsequently sends them to server 40, which receives them encrypted and stores them.

The server 30 validates the information of an invoice request made by a company user of the device 10, sends the encrypted request to the server 40, and when the company user device 10 wishes to consult its invoice and payroll files, the server 30 calls server 40, the latter generates and sends the files to server 30, which decrypts them so that they can be read by the company user device 10.

The server 30 processes and organizes the information uploaded by an administrator user device 20 in the artificial intelligence question module, to send the information to the server 50 and store it therein, so that it can later be processed and consulted when be required.

A general or company user of devices 10, when accessing the question module, can ask the question in writing, by voice, by uploading a file, or by some other means known or yet to be known, by which some information type can be input through device 10, which is sent to server 30, that defines the information type received and sends a request to server 50, the latter receives the information, processes it, and sends its response returned to server 30, which processes it to be displayed visually on the device 10 that made the request.

Likewise, a user of the device 10 can register a workshop or conference, as well as all the information about it, from the name, availability date, description, cost, etc., to be stored on server 30, except for multimedia files (images, documents, videos), which are uploaded and saved on server 70. Videos can also be assigned by writing the URL of an external video playback platform system (You tube, Vimeo or similar, known or to be known), information that is also stored in the server 30. The general user device 10 can also make the corresponding payment and access the complete information and video of a workshop, webinar or similar, always being the server 30 intermediary between devices 10 and server 70.

The invoicing and payroll server 40 is responsible for the tasks and processes of all ISI's related to invoicing and payroll. When the invoicing process is carried out, a company user device 10 is verified as real, so that it can upload to the invoicing server the files of its electronic keys/digital signatures, files that are sent to the server 30, which verifies that the file format are correct; Once the above is confirmed, the information and files are encrypted and subsequently sent them to server 40, which receives them already encrypted and stores them.

It is important to mention that all files and ISI's sent and received from server 40 are encrypted, since the main functionality of this server 40 is the security and protection of the stored information, for which high-level firewalls protocols are used to block unauthorized access and keep secure the information.

The files stored on server 40 are only used to stamp the sales invoices and payroll documents that a device 10 has requested before the local Tax Office; for this instruction to be carried out, it is necessary that the request be validated by server 30, which forwards the encrypted request to server 40, which decrypts it, reads the instruction and generates an instruction that is sent to an external government server (Local Tax Office). The external server responds with a file and information that server 40 receives, encrypts and stores, so that later when a company user device 10 needs to consult its invoice and payroll files, it can request it through server 30, which calls server 40, the latter generates two files that it sends back to server 30, which decrypts them so that they can be read by the company user device 10.

The artificial intelligence server 50 is responsible for the artificial intelligence and machine learning functions. The artificial intelligence server has the following modules: question/answer module, intelligent assistant module, service business viability and/or digital products analysis module (data collection and analysis).

When an administrator user of a device 20 uploads information to the question/answer module, all the data captured in this module, from the response, keywords and other information that is uploaded, is sent to server 30 to be processed and organized, later once processed and organized, this information is sent to server 50 and stored therein, to be processed and consulted when required.

A general user or a company user of devices 10, when using the modules to which they have access, can make requests that require the intervention of a server 50, such is the case of the question module, in which the user asks a question either in writing, by voice, by uploading a file, or else, by some other means by which can input some other information type to the device 10, this is sent to server 30, where is defined the information type received and a request is sent to server 50, the latter receives the information, processes it, compares its database, generates a possible response and using machine learning, with the information already stored (whether entered by the devices 20 users, or that generated by itself), it writes a response also considering the stored data of accuracy and acceptance of previous responses.

The already written answer is sent to server 30, which processes it to be displayed visually on the device 10 that made the request.

The web page creation server 60 allows the storage of graphic assets (assets) and template configurations that are available within the server 60. When any company user device 10 enters the web page creation or editing module that is hosted on the device 10, queries the server 30 to confirm if it has access to the module, once confirmed, the access credentials are sent to the server 60, which returns the availability of templates to which it has access or the template previously selected and configured, so that it can be edited for the first time or on multiple subsequent occasions. During this template editing process, there is an exchange of ISI's between device 10 and server 60 (through server 30), confirming the secure loading of information and the reading of the correct information. In this ISI's exchange, text configurations, upload several types of multimedia files and other types of files to be known can be send, which are used within the templates for web page personalization, all these files are stored on server 60. Once editing is complete, the company user will be able to save the changes made and decide whether to publish the web page with the changes made. When the publication is made, the server 60 creates the appropriate configurations so that the web page can be published through the Internet worldwide and can be consulted by any Internet user, visiting the unique web link (URL) that it belongs to the page that was created. When a user of electronic devices (with an operating system that allows them to open web browsers) accesses the created page, by visiting the corresponding URL, the public access request to the page reaches server 30, which confirms that the extension of URL exists and requests information from server 60 to display it, it sends the appropriate ISI's to display the web page as created by the company user that controls that page. Personalized domains of company users may be used when they have one and decide to make the necessary configuration, to do this, they must capture information from the Domain Name System (DNS-Domain Name System) that the system requests, and in these cases, when a user of devices external to system 100 requests access, the process will change, when the public access request information arrives at server 30 to confirm the existence of this URL; a verification of that address from an external server is made through the previously captured DNS, which must respond positively or negatively, if positive, the process continues by requesting the information from server 60, if negative, access is canceled and a access error default page is displayed.

Likewise, an administrator user of the device 20 can access the template configuration information that company users have created, with the purpose of editing the information, deleting it, blocking access to the page, or deleting it completely whether due to inappropriate content, security issues or for some other reason, such as any legal provision, etc. When the latter is done, device 20 requests access and demonstrates its administrator credentials with permissions to server 30, which denies or allows access; once access is granted, it can exchange ISI's with server 60, always being as intermediary the server 30.

The conference and workshop server 70 processes the functions for the systems that allow conferences and workshops to be generated. When a company user of device 10 needs to create a conference and/or workshop, proceeds to subscribe to the user plan that contains these benefits through server 30; once having benefits to access, the server 30 makes a call to server 70 that contains the appropriate information and carries out these processes, so that ISI's are exchanged between device 20 and server 70, all through server 30.

The user of device 10 can registering a conference and/or a workshop for marketing, where the sale price, name, content information will be established and can link the conference video and/or workshop, which can be done in several ways: a) recording a video from its own device 10 through the system 100, where the video will be uploaded and saved on server 70; b) uploading a file with a known or yet to be known video format that the system 100 recognizes; c) writing the URL of an external video playback platform system (YouTube, Vimeo or similar), in which the video to be displayed is hosted, or some other way of sharing a video not yet known.

The company user of device 10 can configure whether the conference and/or workshop will be a single broadcast, for which a date and time is established in which it can be accessed, or if it is open access (once purchased), from an indicated date and time. A general user of devices 10 can view the conferences and/or workshops available in the workshops and conferences module hosted on the device 10, when accessing this module, the server 30 calls the server 70 to receive the conference information and/or workshops available according to the date and time and displays them on the device 10, the user of device 10 can proceed to select one, make the corresponding payment and access the complete information and video, always through the server 30. The server 70 upon receiving the request to play the conference and/or workshop video, verifies whether it has the video stored or only contains the URL link, if the video is stored, it proceeds to perform transmission (streaming) of this to the general user of device 10 to which access has been granted; in the event that it only contains the URL, grants this information to the server 30, so that it makes a call to the external server of the platform system to which it corresponds and through this, allow the general user of device 10 to view the transmission (streaming).

An administrator user of the device 20 with the appropriate permissions can proceed to view the information stored on server 70 of the company user of the device 10 who have created workshops, can edit the information, block the workshop, or delete it completely, which can be done for several reasons, such as inappropriate content, security issues, legal issues, etc. These functions performed by device 20 are performed through the server 30.

In addition to the elements already mentioned, system 100 can use, when necessary, among others, the following servers:
a) Video Servers: The server 30 can be connected to an external server in the cloud dedicated to online video playback, in order to display the videos that users of devices 10 have assigned through a URL. These external servers are dedicated exclusively to connecting with other software systems to display video playback.
b) Map Servers: The server 30 connects to external map servers whose function is to calculate the geo-location of coordinates sent from a device 10 to the server 30, which sends the information to the external server and receives back the location and position on a map.
c) Domain Servers: The server 30 serves as communication with external domain servers, which store the information of the identifying key of the Domain Name System (DNS-Domain Name System) owned by an Internet domain, in order to display information linked to the domain in question, to link properly and to the correct domain server; the DNS address captured by the user of device 10 who configured the web page to the domain to be linked is used.
d) Social Network Servers: The social network servers through their open connection to share information allow the server device 30 to connect and send specific information that wishes to be shared from the system 100 to one of the available social networks to be published.
e) Payment Servers: The external payment servers perform the function of charging for the payment services that the system 100 has available to users, the server 30 connects to these external servers and sends the user payment information, to make the payment directly from the payment method that the user is using, whether using virtual currencies or traditional currencies; once the payment process has been completed, the external server sends the positive or negative collection response to the server 30, so that the result of their payment can be displayed to the user.
f) Video call servers: The server 30 connects to an external video call provider server, to request a link URL through which a video conference scheduled in the service appointments section of system 100 will be made; the server 30 receives the URL to display it and deliver it to the users of devices 10 corresponding to the scheduled appointment. Once the URL of the external server is clicked, the entire video call process is carried out through the external server using systems of the external servers.
g) Servers of the local Tax Office: The server device 40 connects to an external server of the local Tax Office to carry out the invoicing stamping process, since only servers authorized by the Local Tax Office can carry out this process; server 40 sends the appropriate and necessary ISI's to the external server so that it can carry out the stamping process and return the document with data of the stamped invoice; server 40 receives the information and performs the processes previously described to continue its invoicing process.

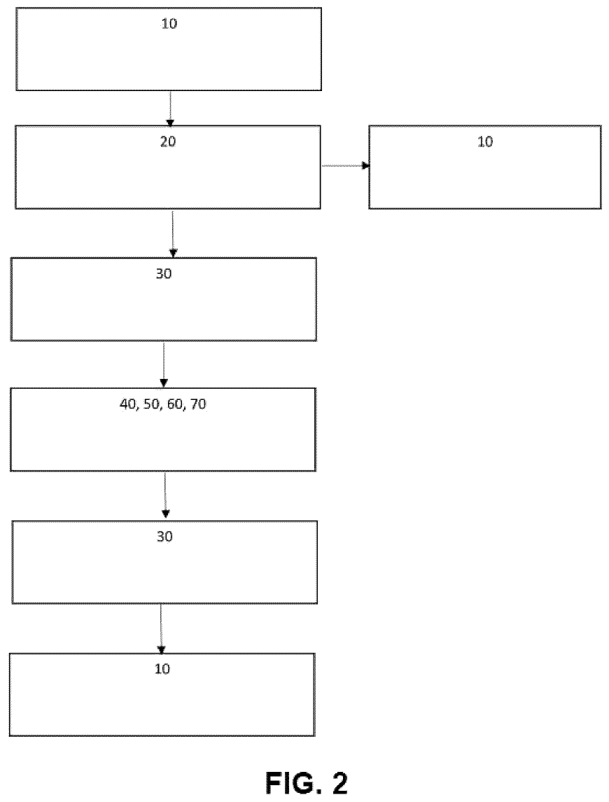

It is important to mention that the system to manage and generate information exchanges between users virtually 100, presents multiple types of operations and functionalities according to the user type and its objective with the system 100; therefore, with reference now to FIG. 2, a general operating mode is shown for the system 100 (operating method), where a user, through a device for receiving and sending Instructions and Information Requests 10, generates an information request containing information about a module required by the initial user and identification information of an end user; the information request is received by the administrative control device 20, which processes the information contained in the information request to determine whether the end user is a qualified or unqualified user, where: if the end user is a qualified user, the control device 20 generates a control, configuration, and authorization request, containing information about the required module and identification information of the end user, and sends it to the general module server 30, and if the end user is a not qualified user, the control device 20 sends a rejection message to the device for receiving and sending Instructions and Information Requests 10; The general module server 30 processes the information contained in the control, configuration, and authorization request and sends a link request to a dedicated server (40, 50, 60, 70), the link request contains information about the required module and end user identification information; the dedicated server 40, 50, 60, 70 receives the link request and sends a data link to the general module server 30 containing data of the required module; the general module server 30 receives the data link and sends it to the device for receiving and sending instructions and information requests 10 corresponding to the end user. The information request may contain information about multiple required modules.

In one embodiment of the invention, the end user and the initial user are the same user.

In one embodiment of the invention, the end user and the initial user are different users. When the dedicated server is the invoicing and payroll system server 40, the link request sent from the server 30 additionally contains invoicing request information, wherein the invoicing request information comprises data for issuing invoices; the invoicing and payroll system server 40 receives the link request and sends an invoice generation request to an external server authorized by the local Tax Office to receive a stamp of the invoice; subsequently, the server 40 sends a data link to the general module server 30 that contains data from the required module and invoicing information, which contains invoice files related to the stamp received from the external server authorized by the local Tax Office; The general module server 30 receives the data link and sends it to the device for receiving and sending instructions and information requests 10 corresponding to the end user.

The invoice generation request contains at least one of the following data: data for issuing invoices for the purchase of digital products, data for issuing invoices for purchasing services, or data for issuing payroll receipts.

The invoice files sent by the server 40 may contain XML format files or PDF format files.

When the dedicated server is the artificial intelligence system server 50, the data link contains an interaction module through which the user of the device for receiving and sending Instructions and Information Requests 10 can enter query information, which comprises one or more questions for the server 50; the query information is received by the server 30; the general module server 30 processes the query information and sends a response request to the server 50, the response request contains the query information; the server 50 receives the response request and sends a response to query information, to the general module server 30; the general module server 30 receives the response to the query information and sends it to the device for receiving and sending instructions and information requests 10 through the interaction module.

The response to the query information is automatically generated by the server 50 based on words contained in the query information generated by the user of the device 10.

When the dedicated server is the web page creation system server 60, the data link contains a web page creation module, the user of the device 10 generates a creation request by the web page creation module and is sent to server 30; server 30 receives the create request and sends it to server 50; server 50 receives the creation request and sends web page creation data to server 30; server 30 receives the web page creation data and sends it to device 10; the device 10 receives the web page creation data and generates a web page layout from the web page creation data; the user generates a web page storage request containing the web page layout and sends it to the server 30; server 30 receives the web page storage request and sends it to server 50; the server 50 receives the web page storage request and stores the web page layout contained in the web page storage request.

The web page creation data contains web page templates previously stored on server 50.

The user of device 10, through the web page creation module, can generate a domain request and it is sent to server 30; server 30 receives the domain request and sends it to server 50; the server 50 receives the domain request and generates and saves a domain for the domain request, and sends domain data to the server 30; server 30 receives domain data and sends it to device 10; device 10 receives the domain data.

The server 50 may assign a web page layout stored by user to a domain generated for the same user. The web page design will be displayed when the generated domain is accessed.

When the domain selected by the user of the device 10 is an existing domain on an external server, the user must configure the DNS's of his domain to point to the server 60 which hosts the configuration and information of the web page that the user generated. Once the external configuration has been made, the web page loading process is carried out when a user of devices 10 accesses the web domain, the external server receives the request, through its processes it indicates to the device the DNS's address to which must try to access, subsequently the access request comes to server 60 with the DNS address and name of the corresponding domain; server 60 then displays the web page to the user who made the request, said web page is viewed with the information (textual, images, videos, etc.) and configurations that a user company of device 10 has previously created.

When the dedicated server is the conference system server and workshops 70, the user of the device 10, through a conference module content in the data link can generate a login request, which contains user information to enter a previously created conference or workshop, the login request is sent to server 30; the login request is received by server 30; server 30 sends the login request to server 70; the server 70 receives the login request, server 70, from the information contained in the login request, determines if the user is an authorized user, if the user is not an authorized user, the server 70 generates a rejection message and sends it to server 30, server 30 sends the rejection message to device 10 via the conference module, and if the user is an authorized user, the server 70 allows access to a predetermined event to the user of the device 10 through the conference module.

The predetermined event may be any of the following: a live audio stream, a live video stream, an audio file previously stored on server 70, a video file previously stored on server 70, a live video streaming via external URL link, live audio streaming via external URL link, file obtained via external URL link.

Furthermore, the user of the device 10, through the conference module contained in the data link can generate an event creation request, the event creation request contains data and files about an event, the event creation request is sent to server 30; the event creation request is received by the server 30, the server 30 determines whether the event creation request is an authorized request, if the event creation request is not an authorized request the server 30 generates a rejection message and sends it to server 10 through the conference module, if the event creation request is an authorized request, server 30 sends it to server 70, server 70 receives the event creation request and generates an event with the data and files contained in the event creation request.

The data and files contained in the event creation request may contain textual data related to the event, a date for the event, a time for the event, a title for the event, images, audio files, video files, URL links for connection to external servers, among others.

Even though a preferred embodiment of the present invention has been described and shown in the previous description, it should be emphasized that numerous modifications to it are possible, without departing from the true scope of the invention.

Therefore, the present invention should not be restricted except as required by the prior art and the appended claims.

1.-55. (canceled)

56. A system to manage and generate exchanges of knowledge, data, information and/or databases between users virtually and/or digitally, characterized in that it comprises:
a plurality of devices for receiving and sending Instructions and Information Requests (ISI) (10), where the ISIs made by an initial user are generated and sent to a general module server (30) for processing;
an administrative control device (20) (administrative dashboard), which generates control, configuration and authorization ISIs, and communicates them directly to the server (30), so that they are reflected in the operation or response of this and the other devices according to the action carried out, the device (20) in turn receives database, dates, logbooks ISIs to supervise, authorize, decline, eliminate information, users, modules, sections and other information contained and/or controlled by the server (30);
a general module server (30), which is also interconnected with an administrative control device (20) (administrative dashboard), with a invoicing and payroll system server (40), with an artificial intelligence system server 50, with a web page creation system server (60) and with a conference and workshop system server (70), which intervene in all parts of the ISI's process, the general module server (30) is responsible for receiving and sending information from and in direction of the plurality of ISI reception and sending devices (10), to the administrative control device (20) (administrative dashboard), to the invoicing and payroll system server (40), to the artificial intelligence system server (50), to the web page creation system server (60) and to the conference and workshop system server (70), to process it and allow all the functionalities of the system 100 to be performed, which include, among others: requesting professional services, scheduling a virtual/in-person appointment, scheduling and receiving payments, viewing and sharing news, viewing links and redirecting them, downloading and sharing documents, receiving and answering questions, register users, exchanging electronic messages (chatting), follow-up of virtual/in-person appointments and contracted services, geolocation, unification of services, attention and support to users, simultaneous communication with various users, control of matters, control of records, invoicing, collection, encryption and storage of files and tax data, stamping of payrolls, virtual assistant, web page creation, virtual and/or digital office addresses, known or yet to be known lines of communication, exchange of information, broadcasting of webinars, holding conferences, sending messages, sending newsletters, purchasing office equipment and supplies, transportation services request, payment for contracted services with virtual currencies or traditional currencies, automatic qualification of contracted services, among others, to produce a response in the form of ISI to be sent to a device 20, or else, back to the same device 10, when the ISI received by the server 30 does not correspond to information that will be fully processed in the general modules, it is partially processed in order to be sent to another of the corresponding server devices and complement its processing;
a invoicing and payroll system server (40) that is interconnected to the server (30) and to the other components of the system (100) through said server (30), which receives the ISI's corresponding to invoicing and/or or payrolls, to process them and generate a response that is sent back to the server (30), which forwards said response to one of the devices (10, 20) or both;
the server (40) controls the issuance and stamping of invoices and payrolls in the local Tax Offices for users who use the service, in addition to saving the information of the keys of the local Tax Office of the users to carry out the stamping;
an artificial intelligence system server (50) that is interconnected to the server (30) and to the other components of the system (100) through said server (30), the server (50) when it receives one or some ISI's coming from the device (10), it is responsible for processing it to generate a response that will be sent back to the server (30) where it will be processed and forwarded as appropriate to one of the devices (10, 20) or both; in the server (50) all the information required to execute the processes is stored, such as, among other things, keywords, their frequency, statistics and other relevant information that is required, in addition to saving all this information in a module dedicated to automatic learning (“machine learning”);
a web page creation system server (60) that is interconnected to the server (30) and to the other components of the system (100) through said server (30), said server (60) is linked directly through the server (30) to a user of the plurality of devices (10), so that when any of these devices (10) performs any ISI that corresponds to the web page creation system, the server (30) will operate as an intermediary for indicate which of the personalized configurations of the device (60) corresponds to the user of the device (10), which sends and receives the ISI; the server (30) being designed to store the web pages information that users create using predesigned templates, where each web page will function as a subdomain attached to the main domain of the system;
a server of the conference and workshop system (70) that is interconnected to the server (30) and to the other components of the system (100) through said server (30), which receives the ISIs coming from the devices (10 and 20) that were processed through the server (30) and that correspond to conferences and workshops, for their execution, where the live transmissions (streaming) of videos will be carried out and stored; and,
wherein the plurality of devices for receiving/sending Instructions (10) generate the ISI's that an initial user makes to be able to manage and exchange information, which depend on the digital product type and/or service that the initial user requires, in addition to including said ISI's, personal information of the end user who will obtain the desired digital product and/or service, such as at least its cell phone number or email address; the plurality of devices (10) also including a question module,
wherein the plurality of devices for receiving/sending Instructions (10) includes all those components necessary for the reception, processing, generation and sending of the selected ISI's, as well as all those electronic components necessary for its interconnection with the general module server (30); among which are at least one power source and/or battery; a processor; a ROM type memory unit; a RAM type memory unit; a network card; an input peripheral; and an output peripheral; such as, among others, computers, cell phones, tablets, automated teller machines, point-of-sale terminals, among others.

57. The system in accordance with claim 56, further characterized in that the digital products and/or services available are among others:
a) ask questions using a question module located on device (10), in addition to being able to view the answers to the questions previously asked by other devices (10) and being able to share them in known and yet to be known digital and/or virtual communication systems, by sending these systems a unique URL and metadata (URL—Uniform Resource Locator); the questions are captured in the question module and are sent to the server 30 that stores them and the latter sends a notification to the device (20) indicating the creation of a new question, so that a user of the device (20) can view the question and capture a response that is sent and stored on server (30) for viewing by the user of the device (10) that asked said question; the user of one of the devices (20) can authorize the question and answer to be viewed by all users of the devices (10), it can also create from the interface of the devices (20) a question, its answer and authorize it to be saved on server (30) and can be viewed by the users of the devices (10) with permission to access them;
b) register users in the general or company mode, whose information is stored in the server (30), which notifies the devices (20) for review and authorization of user type, the device (20) after verifying the data, may authorize the entry of device (10) in general or company modality, where the company user modality has more functionalities that are not available for general users, the devices (10) can view the user data stored according to its geolocation to be able to schedule appointments;
c) schedule appointments, so once the date and time is selected, the appointment is stored in the server (30) and a logbook is generated, which is notified to the device (10) and device (20) so that it can be viewed; devices (10) with scheduled appointments have access to a chat module, where they can contact to send messages, and attached files, working the server (30) as an intermediary and storing all the chat information, which can be viewed from the device (20) as long as it is authorized; from the first file that is sent, a folder will be created in the record module with the service name to which the chat corresponds and the corresponding appointment, the files that are saved in the record are stored on server (30), these files can be consulted by the devices (10) assigned to that service and any device (20) with authorization; once the service has ended, the files can only be accessed by the device (10) of the user who contracted the service or until the user grants access to other devices (10) during the duration of another service; additionally, even after the service has ended, the authorized devices (20) will always have access to this information;
d) follow up on the contracted service through appointments, for which the users of the devices (10) follow up on the contracted service through an appointment using a calendar with the days and times corresponding to each scheduled meeting, whether in person or virtual, with the assistance of Artificial Intelligence, and/or with technology known and yet to be known; the agenda data is stored on server (30) to be consulted by the devices (10) that correspond to it, or else, through any device (20) with authorization to consult the information logbook; the agenda indicates the appointment data, which are among others: host, participants, meeting link (if it is virtual) or location if the appointment is in person; the virtual meeting link is generated when a device (10) selects said option, the information is sent to server (30) that stores the participant information and schedules the meeting, at that moment a connection is made with a device external to the system by making a request of URL generation to use one of the external services used; the external service returns a response with the URL assigned to said meeting, marking the previously selected user as host, this link redirects to the external service for the virtual meeting application, and is stored on server (30) that made the query, for future access to the information for the corresponding devices (10); in the event that the meeting is in person, the device (10) that is scheduling the appointment sends the information to the server (30), which stores the modality and the corresponding data, when the device (10) tries to select the location of the meeting, the server (30) consults the geolocation of the device (10) in question and, using an external service, sends it the coordinates to be able to position on the map of the external service, the current location of the user of device (10) which is scheduling the appointment; the user can decide to select between that location, a previously stored one or create a new one for the meeting place, when selecting the location on the map, the coordinates are sent again to the server (30) so that it can send it to the external service and receive in response the appropriate information to display on the map and generate the location that must be sent back to the devices (10) that consult the meeting information;
e) unify services between several users of the devices (10), for which a general user, when contracting services with company users, can convert several open services into one, when this is done, all the company users which have selected the general user will be able to contact them and schedule an appointment at the same time, creating a shared meeting or appointment between the user and two or more contracted company users the general user will be able to join the company users in the appointment, and select from himself or a company user which will be the host of the meeting, the user assigned as host can select the meeting type, whether in-person or online, all users of device (10) scheduled in the meeting can accept, or request to reschedule the meeting, if rescheduling is requested, the information is sent and stored on server (30), which in turn sends a notification to all other users of devices (10) assigned to the meeting, with the new time proposal for acceptance, once everyone accepts the date and time, the meeting will be confirmed and stored on server (30) so that when the devices (10) or a device (20) with authorization consult the information of the scheduled meeting, can viewing in the logbook; and,
f) provide attention and support to the users of the general and business devices (10), through a user attention and support module, which can create a matter in which help is requested and is described the problem, information which is sent and saved on server (30), which sends a notification to the authorized device (20) so that it can respond to said request, once the problem is solved, the response of the request is sent to server (30) for storage and sending of the notification to the corresponding device (10), which can consult the response and add a new request for attention if required.

58. The system according to claim 56, further characterized in that the administrative control device (20) (administrative dashboard), receives and generates the ISI's that control the system configurations (100) in its entirety, said ISI's are transferred between the administrative control device (20) and the general module server (30); allows creating registrations and cancellations of administrator users so that they can access the device (20), in addition to granting them permissions so that they can access its modules, in which they can read, edit and/or delete information, such as: access the list of registered users and consult their registration information; consult and edit the information of registered users as companies; as well as registering and deregistering said users, sending the ISIs to the server (30) to be processed and to be able to view the changes on the devices (10); and,
a geolocation location can be consulted, edited or created in the information of the company users, which is sent from the device (20) to the server (30), which upon receiving said information processes it and sends it to an external service to receive the location on a map and process it for future queries of the plurality of devices (10) and devices (20); where the users of the device (20) can consult the status of the company users in relation to the license to use the system (100), the number of contracted modules, among others.

59. The system according to claim 58, further characterized in that the administrative control device (20) allows access to the modules that are hosted on the general services server (30), which are: an artificial intelligence module; a links module; a sales module; a news module; a document module; an electronic invoicing module; a web page module; a module of webinars, workshops and courses; a payment module; and, a reporting module, wherein:
the artificial intelligence module through the device (20) performs the following functions: generating the database for the artificial intelligence system server (50); capture keyword information and possible automatic responses according to the keywords; and, allow the consultation of the certainty percentage in the answer delivered to the users of the devices (10) that make use of this module, so that through machine learning the answers are appropriate and the certainty percentage increases; when the device (20) generates the information, it sends it to the server (30), which processes it to simplify it and send it appropriately to the server (50), which stores it, processes it, generates its own results and statistics; once all this information is processed, is sent back to the server (30), which converts it to a suitable reading mode to be consulted from the device (20);
the link module allows the data of the URL's links to be loaded, which are sent to the server (30) and stored for future consultation by the users of the plurality of devices (10);
the sales module allows a user of devices (20) to view the list of all appointment requests that have been made between general users and company users of the devices (10), this information is consulted on server (30) and the details of all the information can be read, such as, among others: date, company (companies) involved, amount of the transaction(s) carried out, meeting type (virtual or in-person), if in person, geolocation information, chat, files of the generated record, status of scheduled appointments, current status and comments/ratings of completed services;
the news module allows creating and deleting news, once the information is generated, it is sent to a server (30), which stores it so that it can later be consulted by the devices (10), where the news can be programmed to be published automatically on a specific date;
the document module allows generating the information of a document and loading a file of known or yet to be known text format, this information is sent and stored on server (30) to be consulted later from the device (10);
the electronic invoicing module allows consulting the information of the company users that request access to the invoicing module of the devices (10), which is stored on server (30), the users of devices (20) with access to this module will be able to verify the information as truthful; once the information is verified as authentic, the users of the devices (10) will be able to access the invoicing functionalities, where the users of the device (20) will be able to consult all the invoices made by accessing the information stored on server (30);
the web page module allows information that is stored on server (30) to be consulted, said information being the configuration that a company user of devices (10) that has requested the use license of this module has been made for its web page; where the users of the devices (20) with access may access said configuration, consult it, modify it or delete it due to inappropriate content or for any other reason, if a device (20) would like to access the display of the web page, by consulting through the server (30), the page information stored in the server (60) is accessed and consulted to display the web page;
the webinar/workshop/course module allows access to the device (20) to consult the information through the server (30), which processes it to store it and consult it in turn on server (70), in this module the devices (20) with access permission can consult the webinars/workshops/courses, created by the users of the devices (10), this information includes upload date, availability date and cost; where the devices (20) may authorize the availability date once it is confirmed that the content for this module complies with the terms and conditions of use of the module on the side of the devices (10);
the payment module allows the devices (20) with access to the user module that have the appropriate permissions, to consult the use licenses that the company users have contracted, can view the payment method, start date and expiration date of the license, as well as make refunds for payments made; and, that general users can consult the payments recorded for contracting a service to a company user or for requesting access to a webinar/workshop/course, as well as making refunds for payments made; and,
the reporting module generates various reports when consulting and processing the information stored on server (30), said reports being, among others: service sales statistics, contracted licenses, artificial intelligence server behavior statistics, web page traffic statistics, sales statistics of courses/workshops/webinars, or else, any other report of key performance indicators.

60. The system in accordance with claim 59, further characterized in that the users of the devices (20) that have authorization will be able to consult the information entered by other devices (20) for possible keywords with their corresponding responses and categories to those correspond, the user of devices (20) with the appropriate permissions can, in addition to consulting all the information, from whom and when this information was entered, edit it and authorize it so that the server (30) marks the information as visible to the plurality of devices (10).

61. The system according to claim 59, further characterized in that the payment method can be any payment method known or to be known through the Internet, using virtual currencies or traditional currencies, or else, through the generation and exchange of intangibles (digital products and/or services), recognized and shared by users, to which a previously agreed value is assigned.

62. The system according to claim 56, further characterized in that the general module server (30) receives and sends information from and in direction of the plurality of ISI's reception and sending devices (10), to the administrative control device (20) (administrative dashboard), to the invoicing and payroll system server (40), to the artificial intelligence system server (50), to the web page creation system server (60) and to the server of the conference and workshop system (70), to process it and allow all the functionalities of the system (100) to be carried out; wherein:
the general module server (30) stores all the data of general users, company users and administrator users, as well as all the permissions that each of them have to access the modules and to view the information they can consult, among others; in addition to controlling all the notifications that are generated in the system (100), which in addition to storing the logbook of notifications, assigns and distributes each of these according to the device, the user type, corresponding module, or notification type;
the general module server (30) stores the questions and answers generated between the device for receiving and sending instructions (10) and the artificial intelligence system server (50), and sends the questions asked to the server (50) so that they can be processed and receive a response, in addition to serving as an interconnection with an external server to share outside the system the questions that users wish to share; these servers can be several external systems and communicate through their web services to link, by sending ISI's to these systems, a unique URL and metadata; where when a user of one of the administrative control devices (20) (administrative dashboard) authorizes the question and answer to be viewed by all users of the devices 10, this information is stored in the general module server (30);
the general module server (30), when a public access request arrives to a web page created in the system (100), confirms that the URL extension exists and requests the information to display it to the server (60); in addition, personalized domains of company users can be used, so when the public access request information arrives at the server (30), a verification is made to an external server, which responds positively or negatively, if positive, the process continues by requesting the information from the server (60), in the negative case the access is canceled and a access error default page is displayed;
when a company user device (10) loads its electronic keys into the invoicing module, these files are sent to the server (30), which verifies that the file format are correct, it encrypts them and subsequently sends them to the server (40), which receives them encrypted and stores them; likewise, the server (30) validates the information of an invoice request made by a company user of the device (10), sends the encrypted request to the server (40), and when the company user device (10) requires consulting its files of invoices and payrolls, the server (30) calls to the server (40), which generates and sends the files to server (30), where they are decrypted so that they can be read by the company user device (10);
the server (30) processes and organizes the information uploaded by an administrator user device (20) in the artificial intelligence question module, to send the information to the server (50) and store it in it, so that it can later be processed and consulted when required; is where a general users or company users of the devices (10), upon accessing the question module, can ask the question in writing, by voice, by uploading a file, or by some other means known or to be known, by which can input some type of information, which is sent to server (30), which defines the type of information received and sends a request to the server (50), which receives the information, processes it, and sends its response back to the server (30), which processes it to be displayed visually on the device (10) that made the request.
a user of the device (10) can register a conference and/or a workshop, including the name, availability date, description, cost, etc., to be stored in the server (30), except the multimedia files that are uploaded and saved on server (70), where the videos can be assigned by writing the URL of an external video playback platform system known or to be known, information that is also stored on the server (30); the general user device (10) being able to make the corresponding payment and access the complete information and video of a workshop, webinar or similar, the server (30) being the intermediary between the devices (10) and the server (70).

63. The system according to claim 62, further characterized in that the general module server (30):
stores the information of the device (10) when registering users in the company mode;
stores the status of the device (20) when authorizing the entry of the device (10) in company mode;
when scheduling appointments, it stores the information in a logbook with users, schedules, locations, video call links and the chat module of the devices (10) generates a history of conversations and shared files, whose ISI's are also stored on server (30);
stores in encrypted form, the user records generated during the services performed in the system;
when a device (10) selects and generates the virtual meeting link option, the information is sent to server (30) to be stored; the server makes a connection with an external device by making a URL request for the use of one of the external services; the external service generates a URL for said meeting, and it is stored on server (30);
when locations are required to be generated, the server (30) consults the geolocation of the device (10), for which, using an external service, send to this the coordinates and receives as response the information to display and generate the location that is sent back to the devices (10) that consult the information;
stores the edition of information of general or company users carried out by the administrator users of the devices (20), as well as the authorization or deletion of information, including the data of who and when made the movements;
receives the information from the artificial intelligence server (50) and converts it into information that can be consulted by devices (20);
stores the news uploaded by the administrator users of the devices (20), so that they can later be consulted by the devices (10), controlling the publication date;
stores the files coming from the document module of the device (20), so that they can be consulted later from a device (10);
stores the configuration information of a company user who has requested a license of the web page module for its personalized page; the images, videos information and other types of graphic assets (assets) is stored directly on server (60) and the server (30) functions as an intermediary to accommodate said information and files; stores all payment information of use licenses, as well as payments for services, conferences, workshops, webinars and other functions or accesses that require payments, this information includes dates, amounts, corresponding services, validity of licenses, periodicity, among other data; and,
stores and processes the reports generated by the users of the devices (20), these being, among others, service sales statistics, contracted licenses, statistics on the behavior of the artificial intelligence server, web page traffic statistics, sales statistics of the courses/workshops/webinars, or any other report of key performance indicators.

64. The system according to claim 56, further characterized in that the billing and payroll server (40) is in charge of the tasks and processes of all the ISI's related to billing and payroll, so when the billing process is carried out, a company user device (10) is verified as real, so that it can upload the files of its electronic keys/digital signatures to the billing server, files that are sent to the server (30), which verifies that the format of the files are correct; once the above is confirmed, the information and files are encrypted, to later send them to the server (40), which receives them already encrypted and stored; said stored files are used to carry out the stamping of sales invoices and payroll documents before the tax authority or local tax office, which a device (10) has requested; in order for this instruction to be carried out, it is necessary that the request be validated by the server (30), which forwards the encrypted request to the server (40), it decrypts it, reads the instruction and generates an instruction that is sent to an external government server or tax office, the external server responding with a file and information that the server (40) receives, encrypts and stores, so that later when a company user device (10) requires to consult its invoice and payroll files, it can request it through the server (30), which calls to the server (40), the latter generates two files that it sends back to the server (30), which decrypts them so that they can be read by the company user device (10).

65. The system according to claim 56, further characterized in that the artificial intelligence server (50) is responsible for the artificial intelligence and machine learning functions, for which it has a question/answers module, an intelligent assistant module, a service business viability and/or digital products analysis module; When an administrator user of a device (20) uploads information to the question/answer module, all the captured data is sent to server (30) to be processed and organized, to later be sent and stored on the server (50), to be processed and consulted when required; and, when a general user or a business user of the devices (10) asking a question either in writing, by voice, by uploading a file, or by some other means by which some other type of information can be entered, this is sent to server (30), where the type of information received is defined and a request is sent to server (50), which receives the information, processes it, compares its database, generates a response and, using machine learning, writes the response considering the stored precision and acceptance data of previous responses, the already written response is sent to server (30), which process to be displayed visually on the device (10).

66. The system according to claim 56, further characterized in that the web page creation server (60) allows the storage of graphic assets (assets) and template configurations that are available within the server (60); when a company user device (10) enters the web page creation or editing module, it consults the server (30) to confirm if it has access, once confirmed, the access credentials are sent to the server (60), which returns the availability of templates or the previously selected and configured template, so that it can be edited; during this template editing process, there is an exchange of ISI's between the device (10) and the server (60) through the server (30), confirming the secure loading of information and the reading of the correct information, in this exchange of ISI's text configurations can be sent, loading of different multimedia files types and other types of files known or unknown, for the customization of the web page; once the edition is completed, the company user will be able to save the changes made and publish the web page; when the publication is made, the server (60) creates the appropriate configurations so that the web page can be published through the Internet network worldwide and can be consulted by any Internet user, visiting the unique web link (URL) that belongs to the page that was created; when a user of electronic devices accesses the created page, the public access request to the page reaches the server (30), it confirms that the URL extension exists and requests the information from the server (60) to display it, it sends the appropriate ISIs to display the web page; will be able to use personalized domains of company users, for this they must capture the information from the Domain Name System (DNS-Domain Name System) that the system requests; when a user of devices external to the system (100) requests access, upon arrival the public access request information to the server (30), through the DNS previously captured, a verification of that address of an external server is carried out, which must respond positively or negatively, if positive, it continues with the process requesting the information from the server (60), if it is negative, access is canceled; and, an administrator user of device (20) can access the template configuration information that the company users have created, with the purpose of editing the information, deleting it, blocking access to the page or delete it completely; when the latter is done, the device (20) requests access and demonstrates its administrator credentials to the server (30), which denies or allows access; once the access is granted, it can exchange ISI's with the server (60) with the server (30) acting as intermediary.

67. The system according to claim 56, further characterized in that the conference and workshop server (70) processes the functions for the systems that allow generating conferences and workshops, when a company user of device (10) requires creating a conference, proceeds to make the subscription to the user plan that contains these benefits through the server (30), once it has the benefits to access, the server (30) calls to the server (70) that contains the appropriate information and performs these processes, so that ISI's are exchanged between device (20) and server (70), all through the server (30); and, a user of the device (10) can enable the registration of a workshop for marketing, where the sale price, name, content information will be established, and the workshop video can be linked, which can be done in several ways: a) recording a video from its own device (10) through the system (100), where the video will be uploaded and saved on server (70); b) loading a file with a known or to be known video format that the system recognizes (100); c) write the URL of an external video playback platform system, in which the video to be display is hosted, or some other way of sharing the video, known or to be known.

68. The system according to claim 67, further characterized in that a company user of the device (10) can configure whether the workshop will be a single broadcast, for which it is established a date and time in which it can be accessed, or else, if it is open access, from an indicated date and time; a general user of devices (10) can view the workshops available in the workshops and conferences module that is hosted on the device (10), by accessing this module; the server (30) calls the server (70) to receive information on available workshops according to the date and time and displays them on the device (10), the user of device (10) can proceed to select one, perform the corresponding payment and access the complete information and video, through the server (30); the server (70) upon receiving the request to play the video of a workshop, check if it has the video stored or it only contains the URL link, If the video is stored, it proceeds to transmit it (streaming) to the general user of the device (10) who has been granted access, if it only contains the URL, it gives this information to the server (30), so that it calls to the external server and through it, allows the general user of the device (10) to view the transmission (streaming); and, an administrator user of device (20) with the appropriate permissions, can proceed to view the information stored on the server (70) of the company users of the device (10) that have created workshops, it can edit the information, block the workshop or delete it completely, for inappropriate content, for security reasons, for legal reasons, etc., these functions are performed through the server (30).

69. The system according to claim 56, further characterized in that the system (100) can use, among others when required, the following servers: video servers, map servers, domain servers, social network servers, Sagos servers, video-call servers, local Tax Office servers.

70. A method to manage and generate exchanges of knowledge, data, information and/or databases between users virtually and/or digitally that includes:
generating, by means of a device for receiving and sending instructions and information requests (10), an information request that contains information about a module required by an initial user and identification information of an end user;
receiving, through an administrative control device (20), the request for information, and process, through the administrative control device (20), the information contained in the information request;
determining, through the administrative control device (20), whether the end user is a qualified or unqualified user, where: if the end user is a qualified user, generate, through the administrative control device (20), a control, configuration, and authorization request, which contains information about the required module and the identification information of the end user, and send the control, configuration, and authorization request to a general module server (30), and if the end user is a unqualified user, send, through the administrative control device (20), a rejection message to the device for receiving and sending instructions and information requests (10);
processing, through the general module server (30), the information contained in the control, configuration, and authorization request and send, through the general module server (30), a link request to a dedicated server (40, 50, 60, 70), the link request contains information about the required module and end-user identification information;
receiving, through the dedicated server (40, 50, 60, 70) the link request and sending, through the dedicated server, a data link to the general module server (30) containing data of the required module; and,
receiving, through the general module server, the data link and send, through the general module server, the data link to the device for receiving and sending instructions and information requests (10) corresponding to the end user.

71. The method according to claim 70, further characterized in that the information request may contain information about multiple required modules, or the end user and the initial user are the same user, or the end user and the initial user are different users.

72. The method according to claim 70, further characterized in that, when the dedicated server is a server of the billing and payroll system (40), the link request sent from the server (30) additionally contains billing request information, where the billing request information includes data for issuing invoices; and the method further comprises:
receiving, through the billing and payroll system server (40), the link request and send, through the billing and payroll system server (40), an invoice generation request to an external server authorized by the Local Tax Office to receive an invoice stamp;
sending, through the server (40), a data link to the general module server (30) that contains data of the required module and billing information, which contains billing files related to the stamp received from the external server authorized by the Local Tax Office;
receiving, through the general module server (30), the data link and send, through the general module server (30), the data link to the device for receiving and sending instructions and information requests (10) corresponding to the end user.

73. The method according to claim 72, further characterized in that the invoice generation request contains at least one of: data for issuing invoices for the purchase of digital products, data for issuing invoices for purchasing services or data for issuing of payroll receipts, and the invoice files sent by the server (40) may contain XML format files or PDF format files.

74. The method according to claim 70, further characterized in that, when the dedicated server is an artificial intelligence system server (50), the data link contains an interaction module, and the method further comprises:
entering, through the device for receiving and sending instructions and information requests (10), query information, which includes one or more questions for the server (50);
receiving, through the server (30), the query information;
processing, through the general module server (30), the query information and sending, through the general module server (30), a response request to the server (50), the response request containing the query information;
receiving, through the server (30) the response request and send, through the server (50), a response to the query information to the general module server (30);
receiving, through the general module server (30), the response to the query information and send, through the general module server (30), the response to the query information to the device for receiving and sending instructions and information requests (10) through the interaction module.

75. The method according to claim 74, further characterized in that the response to the query information is automatically generated by the server (50) based on words contained in the query information generated by the user of the device (10).

76. The method according to claim 70, further characterized in that, when the dedicated server is a server of the web page creation system (60), the data link contains a web page creation module, and the method comprises besides:
generating, through the device (10), a creation request through the web page creation module and send, through the device (10), the creation request to the server (30);
receiving, through the server (30), the creation request and send, through the server 30, the creation request to the server (50);
receiving, through the server (50), the creation request and send, through the server 50, web page creation data to the server (30);
receiving, through the server (30), the web page creation data and send, through the server (30), the web page creation data to the device (10);
receiving, through the device (10), the web page creation data;
generating, through the device (10), a web page design from the web page creation data;
generating, by means of the device (10), a web page storage request containing the web page design and sending, by means of the device (10), the web page storage request to the server (30);
receiving, through the server (30), the web page storage request and send, through the server (30), the web page storage request to the server 50;
receiving, through the server (50), the web page storage request; and
storing, through the server (50), the web page design contained in the web page storage request.

77. The method according to claim 76, further characterized in that the web page creation data contains web page templates previously stored on the server (50).

78. The method according to claim 76, further characterized because it additionally includes: generating, by the web page creation module of the device (10), a domain request and sending, by the device (10), the domain request to server (30);
receiving, through the server (30), the domain request and send, through the server 30, the domain request to the server (50);
receiving, through the server (50), the domain request;
generating and saving, through the server (50), a domain for the domain request, and sending, through the server 50, domain data to the server (30);
receiving, through the server (30), the domain data and send, through the server (30), the domain data to the device (10);
receiving, through the device (10), the domain data.

79. The method according to claim 78, further characterized because it also includes: assigning, by the server (50), a web page design stored per user for a domain generated for the same user, wherein the web page design will be displayed when the generated domain is accessed.

80. The method according to claim 70, further characterized in that, when the dedicated server is a conference and workshop system server (70), the data link contains a conference module, and the method further comprises:
generating, through the device (10), a registration request, which contains user information to enter a previously created conference or workshop, and send, through the device (10), the registration request to server (30);
receiving, through the server (30), the registration request, and send, through the server (30), the registration request to the server (70);
receiving, through the server (70), the registration request, and from the information contained in the registration request, determine, through the server (70), if the user is an authorized user, if the user is not an authorized user authorized, generate, through the server (70), a rejection message and send, through the server (70), the rejection message to the server (30); receive and send, through the server (30), the rejection message to the device (10) through the conference module, and if the user is an authorized user, allow access, through the server (70), to a predetermined event to the user of the device (10) through the conference module.

81. The method according to claim 80, further characterized in that the predetermined event may be any of the following: a live audio stream, a live video stream, an audio file previously stored on the server (70), a video file previously stored on the server (70), a live video stream via an external URL link, a live audio stream via an external URL link, a file obtained through an external URL link.

82. The method according to claim 70, further characterized in that, when the dedicated server is a conference and workshop system server (70), the data link contains a conference module, and the method further comprises:
generating, through the device (10), an event creation request, the event creation request contains data and files about an event, and send, through the device (10), the event creation request to the server (30);
receiving, through the server (30), the event creation request,
determining, through the server (30), whether the event creation request is an authorized request; if the event creation request is not an authorized request, generate, through the server (30), a rejection message and send, through the server (30), the rejection message to the server (10) through the conference module; if the event creation request is an authorized request, sending, through the server (30), the event creation request to the server (70),
receiving, through the server (70), the event creation request and;
generating, through the server (70), an event with the data and files contained in the event creation request.

83. The method according to claim 82, further characterized in that the data and files contained in the event creation request may contain textual data related to the event, a date for the event, a time for the event, a title for the event, images, audio files, video files, URL links for connection to external servers, among others.
